(19) United States
(12) Patent Application Publication
(10) Pub. No.: US 2004/0208970 A1
(43) Pub. Date: Oct. 21, 2004

(54) Microwave prepared foodstuff

(75) Inventors: Lee W. Reuter, Fargo, ND (US); Aimin Guo, Fargo, ND (US)

Correspondence Address: NAWROCKI, ROONEY & SIVERTSON, SUITE 401, BROADWAY PLACE EAST, 3433 BROADWAY STREET NORTHEAST, MINNEAPOLIS, MN, 554133009

(73) Assignee: Drayton Enterprises, L.L.C.

(21) Appl. No.: 10/838,455

(22) Filed: May 4, 2004

Related U.S. Application Data
(63) Continuation of application No. 10/117,357, filed on Apr. 4, 2002, now abandoned.

(51) Int. Cl. A23G 3/00

(52) U.S. Cl. 426/549

(57) ABSTRACT

A rolled pastry composition, capable of microwave cooking from a raw frozen condition so as to have a “fresh baked” quality and character, is provided. The composition includes a dough, a cinnamon smear coating a portion of the dough, and an activatable colorant receivable upon the surface of the rolled pastry composition which, upon heating of the raw frozen composition, provides a brown “fresh baked” color for the finished pastry. The dough comprises a dual leavening system such that the rolled pastry composition volumetrically expands by about 1.5 to 3 times during microwave baking from a raw frozen condition.

### TECHNICAL FIELD

The present invention relates generally to specialty food products, and more particularly, to food products such as sweet rolls which are capable of economic mass production and can be subsequently and preferably placed in frozen storage, the raw frozen composition capable of microwave cooking without loss of palatability or general aesthetic quality/character.

### BACKGROUND OF INVENTION

Food preparation reflects, and food science generally has responded to, our continued pursuit of increased leisure time. With a “9 to 5” work day a thing of the past, reliance upon pre-prepared foodstuffs has increased dramatically. Without a doubt, the microwave oven is the most used appliance in the kitchen, morning, noon and night.

The variety of pre-prepared foodstuffs for heating or re-heating is a proverbial cornucopia, ranging from the “tried and true” to the cutting edge gourmet (e.g., just look at the range of frozen pizzas commercially available: plain cheese to exotic three mushroom pesto varieties, and anything in between). Breakfast items, single serve entrees, family style dinners, snack items, breads, pastries, cakes, cookies etc. abound in the refrigerated cases of the grocer, all ready for “heat/cook-n-serve” to compliment our helter-skelter life style. With such foodstuffs being increasingly available in response to consumer demand, the quality and overall character of such items remains a focal point for food scientists. Although great strides are being made in specialty food quality, there remains a need for improvement in areas of palatability and aesthetic. The consumers know what they like: as attributed to the fabled Don Quixote, “the proof of the pudding is in the eating.”

A critical consideration for food technologists is the manner in which food stuffs are to be cooked. The time saving advantages of convenience/specialty foods are further complemented by the speed of preparation which is made possible by microwave cooking, however, this favored preparation methodology presents particularly challenges for food technologists.

Microwave heating is a method of generating or developing heat in non-conductive materials by molecular agitation caused by stresses resulting from rapidly alternating electrical fields. As is well known, microwave cooking is based upon the ability of microwaves (i.e., electromagnetic waves having a frequency of about 2.45 gigahertz or 2,450,000,000 cycles per second) to interact with the components of a food product and generate heat energy. The amount of interaction and subsequent heat that is generated is related to the composition of the food and the specific heat of each ingredient. Food molecules which carry an electrical charge will vibrate back and forth (i.e., 2.45 billion times each second) as they align themselves with the rapidly fluctuating electric field. This causes heat of friction within the molecules. While water molecules are not electrically charged overall, they do have electrically charged ends (i.e., they are dipolar, having a positively and negatively charged ends). Since water carries a dipolar charge, foods containing high contents of water will generate a great deal of heat which is used to cook the water containing item. Because a microwave oven operates to act on and heat the portions of the product containing the water, but do not act on the air space surrounding the product, the heat is effectively applied only where moisture exists.

Although microwave cooking is greatly influenced by the dielectric properties of ingredients, it is also affected by the food product's physical state, density, size, shape and thickness. The greater a food product's density, the greater the microwave energy absorption and the lower the microwave penetration depth. Also, the shape of food and uneven patterns in a microwave can result in nonuniform temperature distributions.

Especially problematic has been the use of microwave energy for heating or cooking traditional leavened food products such as bread and roll products. Traditional bread and roll products very easily become impalatable after short exposures to microwave energy. The term palatable or palatability refers to the eating quality of food products. Palatable food products are agreeable to the taste and possess an appetizing appearance and texture.

Upon exposure to microwave energy, the crust of traditional bread and roll products becomes extremely tough. The crust of such microwave exposed products may become so tough that it is difficult to tear such products. The bread product itself may become soggy or develop hard lumpy portions. The crumb of the products becomes rubbery and gummy and is difficult to chew. Consequently, traditional bread and roll products, upon exposure to microwave energy, are not palatable.

In intermediate to low moisture foods, such as baked goods, dramatically different patterns of starch transformation can exist which normally are responsible for poor textures such as toughening and cracking. The primary problem is that dehydration cannot occur at the surface since the water within the product is continually being converted to steam and migrating out, causing evaporative cooling and condensation at the surface. This provides a wet or soggy surface texture. Water boils at 100° C. and its heat exchange capability diminishes as it evaporates as steam. The ability of ingredients to evenly distribute heat in a microwaveable dough products will depend on both their specific heat and their relationship with water.

Attempts have been made to deal with the problems associated with exposure of bread and roll products to microwave radiation, but have met with limited success. Methods for making bread and roll products for microwave applications have been tried using “rich” formulations. These “rich” formulations are low in water and high in sugar, shortening and egg. Foodstuffs prepared according to the “rich” formulation absorb microwave energy more slowly than do the traditional baked products because of the lower moisture content of the “rich” products.

Thus, there remains substantial room for improvement regarding leavened foodstuffs intended for heating and/or cooking in a microwave, more particularly, leavened food stuffs which approach in overall character and quality (e.g., taste, appearance, palatability, etc.) those of “fresh baked” food stuffs. It is believed especially advantageous to provide a sweet roll formulation amenable to microwave cooking, more particularly still, a raw frozen sweet roll composition which is “ready baked” in a microwave oven to yield a product having an overall character and quality of a fresh, oven baked product. Further still, it is highly desirable to eliminate, or at least greatly reduce, the processing and/or preparation steps associated with the finished food stuff, as by consolidating steps, for instance by combining the traditionally separate proofing step characteristic of leavened dough products with the baking step.

### SUMMARY OF THE INVENTION

A rolled pastry composition, capable of microwave cooking from a raw frozen condition so as to have a “fresh baked” quality and character, is provided. The composition includes a dough and a cinnamon smear coating a portion of the dough. The dough comprises a dual leavening system such that the rolled pastry composition volumetrically expands by about 1.5 to 3 times during microwave baking from a raw frozen condition. The pastry roll is coated with protein reactive ingredients and exhibits a brown color upon heating.

More specific features and advantages will become apparent with reference to the DETAILED DESCRIPTION OF THE INVENTION, and appended claims.

### DETAILED DESCRIPTION OF THE INVENTION

The present invention generally relates to the preparation of leavened dough products which are generally resistant to toughening during microwave cooking, more particularly, a sweet roll composition is provided which is advantageously in a raw frozen condition for cooking in a microwave oven, the resulting food stuff having a fresh baked quality and character. Preferred food stuffs of the subject invention (e.g., cinnamon rolls) generally include a base dough composition characterized, by among other things, a dual leavening system, a cinnamon smear layer and a coated coloring that is invisible before heating, as will be later discussed. Although the following detailed description of the subject invention is specifically directed to a cinnamon roll embodiment, it should be readily appreciated that other food stuffs utilizing and benefitting from the base dough composition formulation are well within the skill of a person of ordinary skill in the art, and are so embraced herein and hereby.

The preferred frozen cinnamon roll generally takes the shape of a cylindrical pastry item. The pastry dough is first made by mixing a dough recipe until uniform. Thereafter, the dough is sheeted in a known way, coated with a smear and the composition is shaped into a cylinder. The cylinder roll is cut into convenient sections, packaged for end user consumption, and directly frozen. Heretofore known microwave sweet roll formulations typically required initial bulk freezing, subsequent ingredient additions, and subsequent packaging for end user consumption.

The raw frozen pastry of the subject invention can be removed from its packaging, and from other pastry products similarly packaged, and directly introduced into a microwave oven for cooking. The dual leavening system of the dough formulation permits expeditious generation of carbon dioxide which will expand the frozen raw cinnamon roll 1.5 to 3 times of its volume within one to two minutes during microwave baking, thereby producing, in combination with other essential dough components, a heretofore unseen finished quality and character in a microwave baked product.

The base dough composition further generally includes high fat content ingredients, for instance shortening and emulsifiers, so as to keep the product soft and greasy. The inclusion of high water binding ingredients, for example, gums, cellulose, soy protein and vital wheat gluten, aid in keeping the product moist. The inclusion of high water, salt and sugar in composition speeds up the heating process in a microwave oven. As previously noted, a further challenge to replicating a conventional or traditional “fresh baked” sweet or cinnamon roll product is the nature of leavening itself, more particularly the time/temperature relationships associated with or exhibited by a microwave energy source and its effects or impact upon leavening generally. When implementing the traditional style of baking with microwave cooking, yeast type doughs will demonstrate no volume or “cell” dough structure. The subject microwave formulation utilizes a biological (i.e., yeast) and chemical leavening (e.g., double acting) system. As will be later discussed, with this approach sodium bicarbonate reacts with sodium aluminum phosphate and monocalcium phosphate in the microwave oven during baking. This reaction produces carbon dioxide in an expeditious manner during typical microwave oven cook times, thus raising the product to a baked appearance. Yeast, which also generates some carbon dioxide, further imparts an appealing flavor to the product.

In the manufacture of the dough of the subject invention, preferred batch wise processing results in a dough batch mass of about 200 to 400 kilograms, with manufacturing in common batch scale processing equipment characteristic of the baking or pastry industry. Preferably, the flour and yeast is after added to all other dry ingredients in the batch processing equipment. Subsequently, the fat content or fatty ingredients of the dough recipe are added along with water, chilled water or an ice-water mixture, along with any additives or other material at relatively low add portions (e.g., vitamin or mineral supplements, natural or artificial sweeteners, baking powder, baking soda, salt, process aids, dough conditioners, antioxidants, colorants, etc.). This mixture is next mixed one minute on low speed, and three minutes on high speed. Thereafter, any reworked dough may be added, this mixture being preferably blended or mixed for one and a half minutes at high speed. It is advantageous that the aforementioned processing steps being carried out at a target temperature of about 65 to 68° F. A preferred dough recipe is as follows:

| | | |
|---|---|---|
| Ingredient | Mass | Parts by Weight |

Dough Recipe

| | | |
|---|---|---|
| Silo Flour | 198.0000 | 44.77 |
| Baking Soda | 5.4000 | 1.22 |
| Fine Gran Sugar | 23.7000 | 5.36 |
| Dry Whole Eggs | 6.0000 | 1.36 |
| Sunb Shrt Flakes | 14.0000 | 3.17 |
| Purewave | 7.4000 | 1.67 |
| Non Fat Dry Milk | 7.4000 | 1.67 |
| D21 Mix* | 19.4000 | 4.39 |
| V.P. Shortening | 45.8000 | 10.36 |
| Water | 101.0000 | 22.84 |
| Yeast | 13.9000 | 3.14 |
| Annatto Coloring | 0.2188 | 0.05 |
| Ascorbic Acid | 0.0250 | 0.01 |
| Total | 442.2438 | 100.00 |

*D-21 Mix as follows:

| | | |
|---|---|---|
| Qk Stp Improver | 2.0 | 10.31/0.45 |
| Myvatex/Monomol D | 2.0 | 10.31/0.45 |
| Ticaloid Lt Pwd | 1.0 | 5.15/0.23 |
| H G Blending Salt | 6.0 | 30.93/1.36 |
| Bake Shure 195 | 1.0 | 5.15/0.45 |
| Sodium Al Phspht | 5.4 | 27.84/1.22 |
| Mono Ca Phspht | 1.3 | 6.70/0.29 |
| Cal Sulfate | 0.5 | 2.58/0.11 |
| B&R Vanilla Pwd | 0.2 | 1.03/0.05 |
| Total | 19.4 | 100.00/4.39 |

As should be readily appreciated, providing select ingredients as a composite or premix (i.e., the premix designated D-21 which includes, among other things, components of the double acting baking powder, or chemical leavening agents more generally) greatly accelerates dough preparation without a deleterious effect with respect to dough performance. It should be further noted that inclusion of these dough constituents as a subassembly is a matter of production convenience, a significant number of time consuming steps being thereby eliminated, not necessity.

The flour of the subject dough preferably is a relatively medium to high protein flour, containing as little as 11 weight percent protein, based upon the weight of the flour including moisture content. Flours having up to about 13 weight percent protein may be utilized in the dough formulation without deleterious product effects. In addition to flour, the dough recipe generally includes fat (i.e., shortening), protein (e.g., dried whole eggs, non-fat dried milk), a dual leavening system (i.e., a combination of biological and chemical leavening agents) sugar, water, emulsifiers (e.g., myvatex/monomul), conditioners (e.g., ascorbic acid, Purewave, Quick Step), colorants (e.g., annatto), gum (e.g., ticaloid lite powder), and flavoring (e.g., vanilla). Select constituents will be subsequently discussed.

As is well known, shortening typically imparts a tenderness and richness to the dough, ultimately improving flavor and texture. In addition to an all purpose shortening (e.g., Ventura all purpose shortening), specialty shortenings, such as Sunburst Shortening Flakes, are advantageous for their dough conditioning and softening ability, as by the inclusion of specialty emulsifiers derived from vegetable sources (i.e., mono and diglycerides).

An essential characteristic of the subject dough is a dual leavening system, more particularly, the combination in the composition of yeast with both baking soda, and the other constituents of a double acting baking powder. The dual leavening system of the dough formulation permits expeditious generation of carbon dioxide which will expand the frozen raw cinnamon roll 1.5 to 3 times of its volume within one to two minutes during microwave baking, thereby producing, in combination with other essential dough components, a heretofore unseen finished quality and character in a microwave baked product.

Baking soda or bicarbonate of soda, typically sodium bicarbonate (NaHCO₃) or alternately potassium bicarbonate (KCHO₃), is alkaline in nature, and when combined with an acid, creates carbon dioxide, giving “rise” to doughs and batters. Since baking soda reacts with water, it should be mixed thoroughly with dry ingredients before the addition of liquids so as to assure even leavening.

Bake sure 195 is a commercially available shortening encapsulated baking powder soda, the shortening coating on the soda will not melt until heated. Thusly, the soda will not react with other acids until it reaches the oven, therefore extending the roll's shelf life in the freezer. This component, upon heating along with the separately identified acids (i.e., sodium aluminum phosphate, monocalcium phosphate and calcium sulfate) synergistically combine in the dough formulation, primarily with the yeast, to provide a quick rise for the sweet roll during microwave cooking. Furthermore, the use of dry whole eggs is particularly advantageously utilized in the subject microwave dough, the commonly omitted egg whites which possess excellent foaming properties assist in the critical leavening process, producing a more voluminous dough.

After sheeting, dividing and gauging the dough in known and accepted ways, a fat smear, as that disclosed in pending patent application Ser. No. 08/655,959, is then applied to the surface of the dough sheet. The fat smear is applied at an add on amount of about 20 to 26 grams per 100 grams of dough. The fat smear is typically added in a thickness of up to about 1 millimeter and can be selectively added to the full, or less than full width of the dough layer.

The fat smear is a sweet layer prepared from either margarine or butter, or a mixture thereof. The smear add on is typically manufactured by combining the margarine or butter component with sweetener materials in common mixing equipment. In the preparation of the smear composition, the fat components (i.e., margarine, butter, butter substitute or other fat ingredient) is commonly introduced into blending equipment. Into the agitated fat is commonly added sugar in the form of brown sugar, granular sugar, high fructose corn syrup or other useful sugar or sugar substitute. The ingredients are mixed until uniform, and the other ingredients, used in lower proportion, are then added to the agitated mixture. Such components can include salt; other flavorings such as vanilla. Careful control over smear add on is important to achieve full coverage. A preferred cinnamon smear generally comprises 19 parts of margarine, about 48 parts by weight of a sugar composition, and about 4.4 parts of a cinnamon spice, a specific formulation is as follows:

Cinnamon Smear Formula

| Ingredient | Parts by Weight |
|---|---|
| Margarine | 19.2 |
| Granular Sugar | 24.1 |
| Brown Sugar | 24.1 |
| Salt | 0.5 |
| Vanilla | 0.2 |
| Nulomoline | 6.4 |
| Vegetable Oil | 8.9 |
| Flour | 12.2 |
| Cinnamon | 4.4 |
| Total | 100.0 |

The generally cylindrical spiral wound pastry can contain at least six to eight layers counting from top of the cinnamon roll to the bottom including the center or starting curl. The pastry has a diameter of greater than five centimeters and a height of greater than seven centimeters. The sheeted dough of the pastry has a thickness greater than about three millimeters. Coated between the rolled layers of dough is a cinnamon smear. The smear is applied to virtually the entire internal surface of the spiral round roll. Sufficient fat smear is applied to the dough to achieve an add-on thickness of about 0.5 to 2.0 millimeters. Having prepared the generally cylindrical roll, it is then cut to length into handleable sub-units for subsequent end-user packaging and freezing. Preparation of the cinnamon rolls of the subject invention includes nothing more than placing an individual or the individual raw frozen rolls in a microwave oven for baking.

The following baking instructions are provided for the raw frozen cinnamon roll of the subject invention: (1) put one frozen cinnamon roll, ring side up, on a microwave safe plate and in the center of a microwave; (2) bake on high in a 900 watt microwave for 1 minute 30 seconds to 2 minutes, the center of the roll being soft when baked (note: microwaves without turntable require the product to be rotated ¼ turn every 45 seconds of cooking time); and, (3) remove from microwave, apply icing as desired.

The fresh roll is then spray or otherwise coated prior to freezing with a colorant, more particularly and preferably, an activatable (e.g., heat catalyzed) coloring agent such as maillose® from Red Arrow Products Co. LLC. The frozen or fresh roll will not exhibit the desired color until heated. Upon heating, the coloring agent reacts with protein in the dough so as to leave an even brown coloring on the surface of the roll without any affects to flavor.

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

What is claimed is:

1. In a microwaveable foodstuff, a dough comprising a dual leavening system, said dough volumetrically expanding by about 1.5 to 3 times during microwave baking from a raw frozen condition.

2. The microwaveable foodstuff of claim 1 wherein said dual leavening system comprises yeast and double acting baking powder.

3. The microwaveable foodstuff of claim 2 wherein said dough comprises about 2.5 to 3.5 parts by weight yeast.

4. The microwaveable foodstuff of claim 2 wherein said dough comprises about 3 parts by weight yeast.

5. The microwaveable foodstuff of claim 3 wherein said dough comprises about 1.5 to 1.75 parts by weight double acting baking powder.

6. The microwave foodstuff of claim 5 further comprising a coating of activatable colorant receivable upon a portion of said dough, upon microwaving said microwave food stuff, said colorant contributing to a visual aesthetic for same.

7. The microwave foodstuff of claim 6 wherein said colorant comprises maillose®.

8. The microwaveable foodstuff of claim 5 wherein said dough further comprises baking soda.

9. The microwaveable foodstuff of claim 5 wherein said dough comprises about 1 to 1.5 parts by weight baking soda.

10. The microwaveable foodstuff of claim 9 wherein said dough further comprises dry whole egg.

11. The microwaveable foodstuff of claim 10 wherein said dough comprises about 1 to 1.5 parts by weight dry whole egg.

12. The microwaveable foodstuff of claim 11 wherein said dough includes about 42 to 46 parts by weight flour.

13. A rolled pastry composition comprising a dough, a cinnamon smear coating a portion of said dough, said dough comprising a dual leavening system, said rolled pastry composition volumetrically expanding by about 1.5 to 3 times during microwave baking from a raw frozen condition.

14. The rolled pastry composition of claim 13 wherein said dual leavening system comprises yeast in combination with double acting baking powder.

15. The rolled pastry composition of claim 13 wherein said dual leavening system comprises yeast in combination with double acting baking powder at a mass ratio of about 1.75 to 2.25.

16. The rolled pastry composition of claim 13 wherein said dual leavening system comprises yeast in combination with double acting baking powder at a mass ratio of about 2.

17. The rolled pastry composition of claim 14 wherein said fat smear comprises about 10 to 30 parts by weight per 100 parts of sheeted dough.

18. The rolled pastry composition of claim 14 wherein said dough further comprises baking soda.

19. The rolled pastry composition of claim 16 wherein said dough comprises about 1 to 2 parts by weight baking soda.

20. The rolled pastry composition of claim 18 wherein said dough further comprises dry whole egg.

21. The rolled pastry composition of claim 20 wherein said dough further comprises about 1 to 1.5 parts by weight dry whole egg.

22. The rolled pastry composition of claim 20 further comprising a coating of activatable colorant receivable upon a portion of said dough, upon microwaving said microwave food stuff, said colorant contributing to a visual aesthetic for same.
